(19) United States
(12) Patent Application Publication
(10) Pub. No.: US 2018/0035164 A1
(43) Pub. Date: Feb. 1, 2018

(54) WIRELESS-CAPABLE REMOTE ANTENNA BOXES AND RELATED SYSTEMS AND METHODS

(71) Applicant: Antennas Direct, Inc., Ellisville, MO (US)

(72) Inventors: Michael Sizemore, Lenexa, KS (US); Chris Justice, Leawood, KS (US); Griffin Adams, Shawnee, KS (US); Joanne Nosiglia, Eureka, MO (US); Christine Hand, St. Louis, MO (US); Nicholas O'Connor, Shawnee, KS (US)

(21) Appl. No.: 15/728,212

(22) Filed: Oct. 9, 2017

Related U.S. Application Data
(63) Continuation-in-part of application No. 15/058,705, filed on Mar. 2, 2016, now abandoned.

(51) Int. Cl. H04N 21/4402; H04N 21/41; H04N 21/4147; H04N 21/4363

(52) U.S. Cl. CPC H04N 21/440218; H04N 21/43637; H04N 21/4122; H04N 21/4147; H04W 88/181

(57) ABSTRACT

Disclosed are exemplary embodiments of audiovisual systems and related methods. In an exemplary embodiment, an antenna box is configured for wired connection with an over-the-air (OTA) antenna. The antenna box is operable to process OTA signals received from the OTA antenna and to wirelessly transmit the processed signals, via one or more wireless-capable devices remote from the antenna box, for play as audiovisual content on one or more display devices remote from the antenna box.

### CROSS-REFERENCE TO RELATED APPLICATION

This application is a continuation-in-part of U.S. patent application Ser. No. 15/058,705 filed Mar. 2, 2016, which published as US2017/0257667 on Sep. 7, 2017. The entire disclosure of the above application is incorporated herein by reference.

### FIELD

The present disclosure generally relates to wireless-capable remote antenna boxes and related systems and methods.

### BACKGROUND

This section provides background information related to the present disclosure which is not necessarily prior art.

Numerous entertainment options, including but not limited to television, cable and Internet-based systems and devices, are currently available for providing a wide range of home entertainment capabilities. One such option, broadcast television, has undergone improvement through conversion to digital broadcasts. Viewers who have installed over-the air (OTA) antennas can obtain free access to broadcast digital content.

### DRAWINGS

The drawings described herein are for illustrative purposes only of selected embodiments and not all possible implementations, and are not intended to limit the scope of the present disclosure.

FIGS. 1 through 4 are diagrams of example audiovisual systems including wireless-capable remote antenna boxes in accordance with various embodiments of the disclosure.

Corresponding reference numerals indicate corresponding parts throughout the several views of the drawings.

### DETAILED DESCRIPTION

Example embodiments will now be described more fully with reference to the accompanying drawings.

The inventors hereof have recognized that television viewers wish to have access to a wide range of audiovisual content, not only on their television sets but also on their smartphones, tablets, personal computers, etc. The inventors also have observed that although outdoor OTA antennas typically provide better signal reception than indoor antennas, significant signal loss can occur along lengthy cabling between an outdoor antenna and an indoor set-top box in which tuning and decoding are typically performed. Additionally, for many consumers, the routing of a typical coaxial cable from the outdoor OTA antenna through a wall or window to the indoor television set, or from an indoor OTA antenna located in one room to a television set in an adjoining room, can be problematic. Common issues that prevent consumers from routing such cables include the lack of skills, lack of tools, and mechanical complications unique to particular dwellings. In some cases, such as when the consumer lives in a rented or leased home, apartment or condominium, consumers are actually restricted from drilling holes and running cables due to clauses in rental or lease contracts. A solution which removes the necessity of drilling a hole and routing a coaxial cable can thus enable many consumers to use an outdoor OTA antenna and enjoy improved reception of available digital TV broadcasts throughout their home.

Accordingly, the inventors have developed and disclose herein exemplary embodiments of audiovisual systems having wireless-capable remote antenna boxes. In one example embodiment, an audiovisual system includes an example antenna box configured for wired connection with an OTA antenna, e.g., configured for installation near an outdoor over-the-air (OTA) antenna. The antenna box may be installed, e.g., on or under a rooftop on which the OTA antenna is installed. The antenna box is operable to process OTA signals received from the OTA antenna and to wirelessly transmit the processed signals, e.g., via wireless-capable device(s) remote from the antenna box, for play as audiovisual content on one or more display devices, including but not necessarily limited to a high-definition television (HDTV), remote from the antenna box. Such wireless-capable device(s) may include set-top devices such as a dongle and/or set-top box. It should be noted generally that embodiments are possible in which an antenna referred to herein as an “outdoor” antenna is installed indoors, e.g., in an attic or other interior location. Possible outdoor locations for such an antenna include but are not limited to installation on a roof, tower, fascia, a mast in a yard, etc. Embodiments also are possible in which an antenna box is configured for wired connection with an antenna made for indoor use. In some embodiments, an antenna box may wirelessly transmit a signal from an indoor antenna, e.g., to a HDTV in the same room as the antenna or in a different room. Such embodiments may be useful, e.g., where the location of a HDTV would not allow for optimal positioning of the indoor antenna. In some embodiments, an antenna, antenna box, wireless-capable device(s), and set-top box may all be indoors.

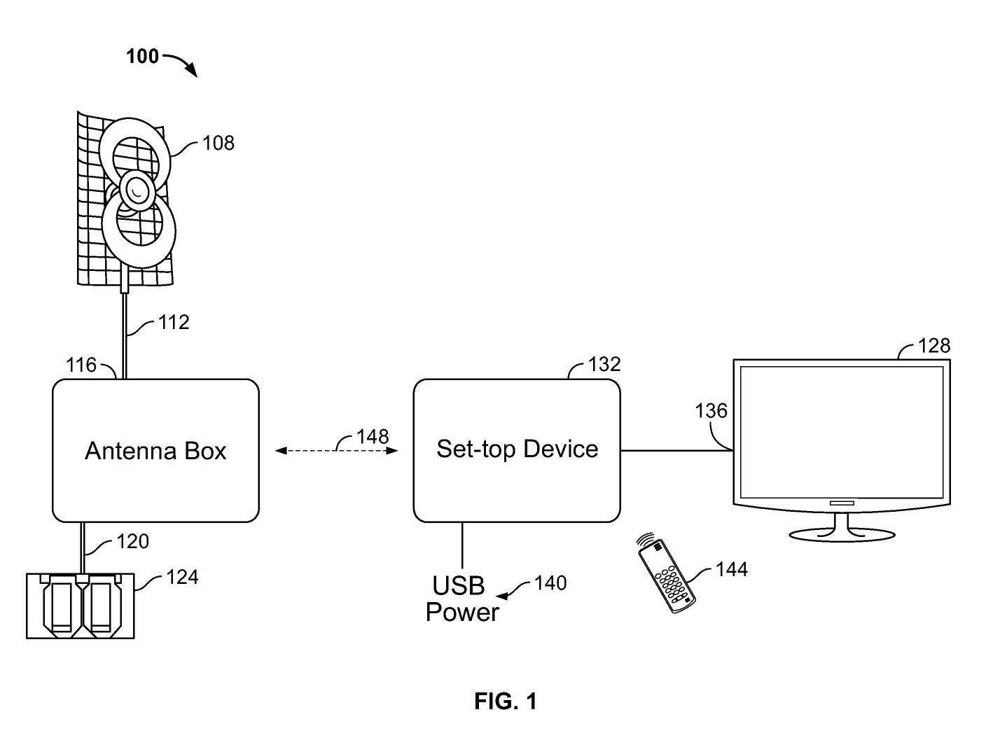

With reference now to the figures, FIG. 1 illustrates an example audiovisual (AV) system 100 embodying one or more aspects of the present disclosure. In various embodiments, the AV system 100 may be provided at a home, office, other structure, etc. In the present example embodiment, the AV system 100 is based at a residence and includes an outdoor over-the-air (OTA) antenna 108 capable of receiving digital media signals. For example, the OTA antenna 108 may receive high-definition television (HDTV) signals that have been multiplexed and broadcast in accordance with ATSC (Advanced Television Systems Committee) standards. The example antenna 108 is available from Antennas Direct of Ellisville, Mo., www.antennasdirect.com. The antenna 108 is an example only, and other or additional outdoor OTA antennas may be used in accordance with various implementations of the present disclosure.

The OTA antenna 108 is, e.g., installed on the roof of the residence and has a wired connection 112 with an antenna box 116. The example antenna box 116 is provided, e.g., on or under the roof, in an attic or at some other location, e.g., near the OTA antenna 108. Embodiments also are possible in which the antenna box 116 is integrated into a housing of the antenna 108. The example antenna box 116 receives power, e.g., through a wired connection 120 to a power supply 124, which may be an outdoor or indoor AC outlet. It is noted that most homes, apartments, and condominiums have at least one outdoor AC outlet that can be used to power an antenna box embodiment. This can eliminate a need for a consumer to drill holes and install AC power cables and outlets and lowers the barrier for consumers wishing to use an outdoor OTA antenna. In the present example embodiment, an antenna box installation location “near the OTA antenna” means a location, e.g., selected so as to minimize the length of the wired connection 112. However, in various embodiments the antenna box 116 may be installed in various indoor or outdoor locations relative to, and at various distances from, the antenna 108. An antenna box installation location may be selected for reasons other than or in addition to minimizing the length of a wired connection to an antenna, such as minimizing the length of AC power cable between the antenna box and the AC outlet.

In the present example embodiment, the antenna box 116 is located remotely from a display device, e.g., a high-definition television (HDTV) 128 located, e.g., in a living room of the residence. The antenna box 116 is operable to process OTA signals received from the OTA antenna 108 and to wirelessly transmit the processed signals, via one or more wireless-capable devices remote from the antenna box 116, e.g., for play on the HDTV 128. The antenna box 116 thus includes, e.g., tuner(s), demodulator(s), a processor, and a wireless communication interface, e.g., a Wi-Fi chip set including a receiver, transmitter, a wireless antenna, and transcoding functionality, e.g., H.264, H.265 and/or other compression technologies.

In various embodiments, the antenna box 116 is configured in a weatherproof enclosure. Additionally or alternatively, the antenna box 116 includes auto-start code for starting antenna box 116 operation when power is applied. In various embodiments, a user is able to use and reconfigure the AV system 100 without being required to interact with the antenna box 116 after the antenna box 116 has been installed. The example antenna box 116 may use multiple tuners/demodulators/processors to provide intelligent channel scanning during setup and/or to acquire information from other channels, where examples of such information may include but are not limited to program guide data, signal strength, etc. Further, the example antenna box 116 may adjust the included transcoding functionality based on information including but not limited to Wi-Fi signal strength, native video resolution, resolution of the display device in use, etc. In various embodiments, the antenna box 116 includes digital video recording (DVR) functionality, including but not limited to pause and/or recording capabilities.

In the present example embodiment, the AV system 100 includes a set-top device, e.g., a dongle 132. Additionally or alternatively, a set-top box could be provided as a set-top device. The dongle 132 is configured for wired and/or plug-in connection with the HDTV 128, e.g., at a HDMI (High-Definition Multimedia Interface) port 136. The dongle 132 includes a processor and a wireless communication interface. In various embodiments, where HDMI Consumer Electronics Control (HDMI-CEC) is enabled on the HDTV 128, a viewer may use one device, e.g., a remote control 144, to control more than one system device. The dongle 132 may receive power, e.g., through a USB (Universal Serial Bus) port 140, which may be provided, e.g., on the HDTV 128 or other power source providing USB access.

In the present example embodiment, the antenna box 116 encodes and wirelessly transmits H.264-encoded video data to the dongle 132 via a protected Wi-Fi channel 148, e.g., using 802.11n Wi-Fi. In some other embodiments, however, other or additional compression technologies and/or wireless protocols could be used. In some embodiments, the remote control 144 and the dongle 132 each include an infrared (IR) communication interface. Additionally or alternatively, the remote control 144 and the dongle 132 each include a radio frequency (RF) communication interface. In various embodiments, the dongle 132 is operable, e.g., by a user using the remote control 144, to download audiovisual content, via the OTA antenna 108 and antenna box 116, from one or more broadcast content sources.

The example AV system 100 makes it possible for a viewer to “plug and play” a HDTV that accepts HDMI input. For example, the viewer can plug in the dongle 132 to connect the antenna 108 and antenna box 116 wirelessly with the HDTV 128 and can then stream broadcast content from the antenna 108 and antenna box 116 for viewing on the HDTV 128. The system 100 also makes it possible for a viewer to “plug and play” a smart TV (i.e., an Internet-capable TV).

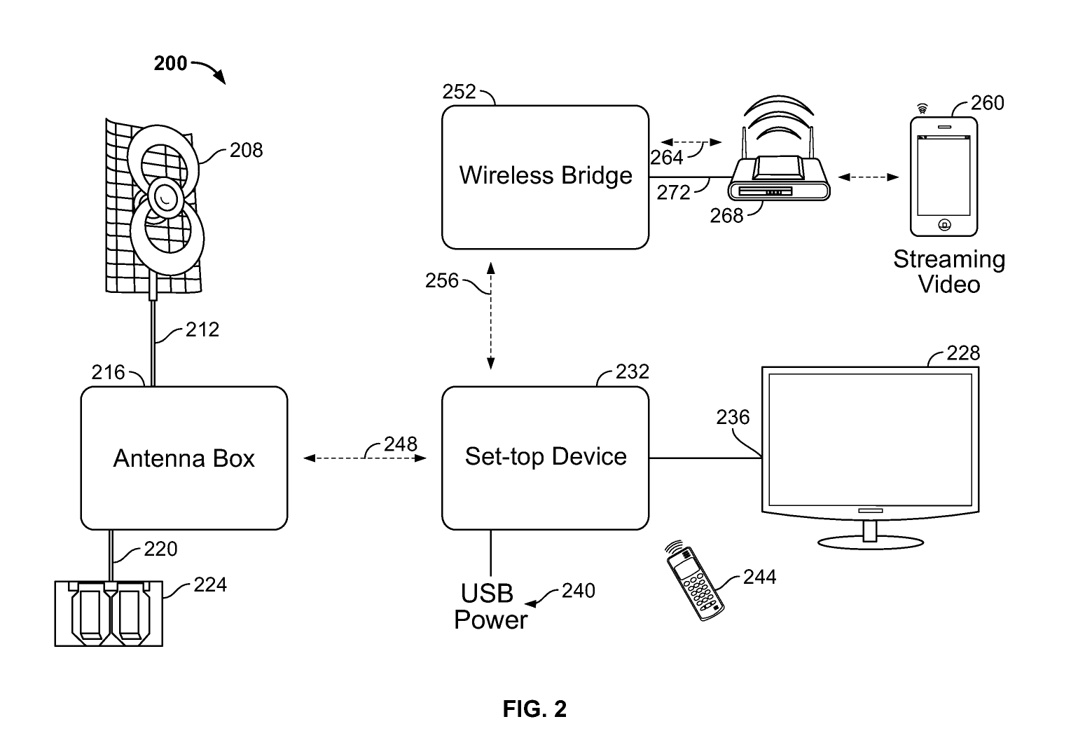

Another example audiovisual (AV) system embodying one or more aspects of the present disclosure is indicated in FIG. 2 by reference number 200. As further described below, the example AV system 200 makes it possible for a viewer to stream broadcast content to more than one display device. The AV system 200 is based, e.g., in a residence and includes an outdoor over-the-air (OTA) antenna 208 capable of receiving digital media signals. For example, the OTA antenna 208 may receive HDTV signals that have been multiplexed and broadcast in accordance with ATSC standards. The OTA antenna 208 is, e.g., installed on the roof of the residence and has a wired connection 212 with an antenna box 216. The antenna box 216 is provided, e.g., on or under the roof, in an attic or at some other location, e.g., near the OTA antenna 208. Embodiments also are possible in which the antenna box 216 is integrated into the antenna 208 housing. The antenna box 216 receives power through a wired connection 220 to a power supply 224, e.g., an outdoor AC outlet.

In the present example embodiment, the antenna box 216 is located remotely from a display device, e.g., a high-definition television (HDTV) 228 located, e.g., in a living room of the residence. The antenna box 216 is operable to process OTA signals received from the OTA antenna 208 and to wirelessly transmit the processed signals, via one or more wireless-capable devices remote from the antenna box 216, e.g., for play on the HDTV 228. The antenna box 216 thus includes, e.g., tuner(s), demodulator(s), a processor, and a wireless communication interface, e.g., a Wi-Fi chip set including a receiver, transmitter, a wireless antenna, and transcoding functionality, e.g., H.264, H.265 and/or other compression technologies. In various embodiments, the antenna box 216 includes digital video recording (DVR) functionality, including but not limited to pause and/or recording capabilities.

In the present example embodiment, the AV system 200 includes a set-top device, e.g., a dongle 232 configured for wired and/or plug-in connection with the HDTV 228, e.g., at a HDMI port 236. The dongle 232 may receive power, e.g., through a USB port 240, which may be provided, e.g., on the HDTV 228 or other power source providing USB access. The dongle 232 includes a processor and a wireless communication interface. Additionally or alternatively, a set-top box could be provided as a set-top device.

In the present example embodiment, the antenna box 216 wirelessly transmits H.264-encoded video to the dongle 232, e.g., over 802.11n Wi-Fi, via a protected Wi-Fi channel 248. In some other embodiments, however, other or additional compression technologies and/or wireless protocols could be used. In the present example embodiment, the set-top dongle 232 is an HDMI-capable device that may be operable, e.g., by a user using a remote control 244, to download audiovisual content to the HDTV 228, via the OTA antenna 208 and antenna box 216, from one or more streaming content sources. Accordingly, in some embodiments, the remote control 244 and the dongle 232 each include an infrared (IR) communication interface. In some other embodiments, the remote control 244 and the dongle 232 each include a radio frequency (RF) communication interface.

Additionally, the set-top dongle 232 may send H.264-encoded broadcast content to a Wi-Fi bridge 252, via a protected Wi-Fi channel 256 using 802.11n Wi-Fi. In some other embodiments, however, other or additional compression technologies and/or wireless protocols could be used. In the present example embodiment, the bridge 252 is configured with two wireless communication interfaces: one interface for wireless communication over the protected channel 256, and the other interface for communication over a WiFi channel 264 in a local network provided in the residence. The bridge 252 is wirelessly accessible in the local wireless network, e.g., by a mobile computing device, e.g., a viewer's smartphone 260, e.g., via an access point/router 268 of the local network. In the present example embodiment, the bridge 252 also includes a wired Ethernet connection 272 with the access point/router 268 that may be used, e.g., instead of the WiFi channel 264. Communication between the access point/router 268 and the smartphone 260 may be, e.g., by 802.11b, 802.11g, 802.11n or 802.11ac. In various embodiments, the smartphone 260 includes transcoding functionality, e.g., H.264, H.265 and/or other compression capability. The smartphone 260 may receive, decode and display broadcast content received from the antenna 208 through the antenna box 216, dongle 232, bridge 252 and access point/router 268.

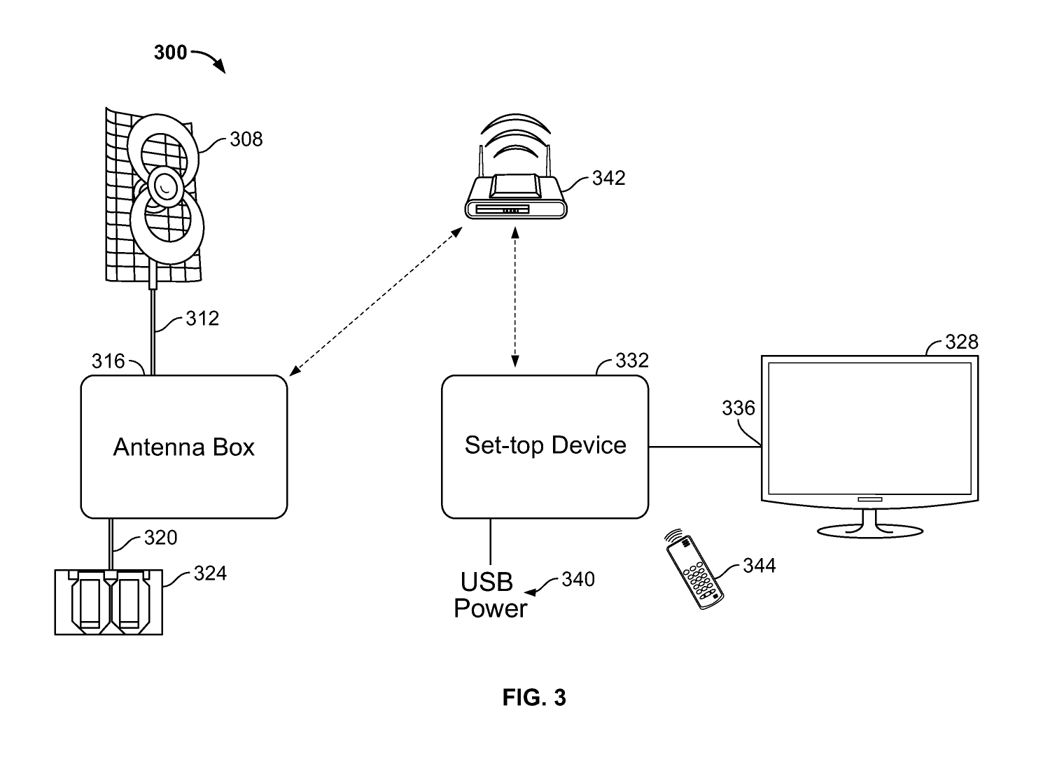

Another example audiovisual (AV) system embodying one or more aspects of the present disclosure is indicated in FIG. 3 by reference number 300. The AV system 300 is based, e.g., in a residence and includes an outdoor over-the-air (OTA) antenna 308 capable of receiving digital media signals. For example, the OTA antenna 308 may receive HDTV signals that have been multiplexed and broadcast in accordance with ATSC standards. The OTA antenna 308 is, e.g., installed on the roof of the residence and has a wired connection 312 with an antenna box 316. The antenna box 316 is provided, e.g., on or under the roof, in an attic or at some other location, e.g., near the OTA antenna 308. Embodiments also are possible in which the antenna box 316 is integrated into the antenna 308 housing. The antenna box 316 receives power through a wired connection 320 to a power supply 324, e.g., an outdoor AC outlet.

In the present example embodiment, the antenna box 316 is located remotely from a display device, e.g., a high-definition television (HDTV) 328 located, e.g., in a living room of the residence. The antenna box 316 is operable to process OTA signals received from the OTA antenna 308 and to wirelessly transmit the processed signals, via one or more wireless-capable devices remote from the antenna box 316, e.g., for play on the HDTV 328. The antenna box 316 thus includes, e.g., tuner(s), demodulator(s), a processor, and a wireless communication interface, e.g., a WiFi chip set including a receiver, transmitter, a wireless antenna, and transcoding functionality, e.g., H.264, H.265 and/or other compression technologies. In various embodiments, the antenna box 316 includes digital video recording (DVR) functionality, including but not limited to pause and/or recording capabilities.

The example AV system 300 includes a set-top device, e.g., a dongle 332 configured for wired and/or plug-in connection with the HDTV 328, e.g., at a HDMI port 336. Additionally or alternatively, a set-top box may be provided as a set-top device. The dongle 332 may receive power, e.g., through a USB port 340, which may be provided, e.g., on the HDTV 328 or other power source providing USB access. The dongle 332 includes a processor and a wireless communication interface. The AV system 300 also includes an access point/router 342, e.g., of a local wireless network provided in the residence. The dongle 332 is configured as a node in the local wireless network.

In the present example embodiment, the antenna box 316 wirelessly transmits H.264-encoded video to the set-top dongle 332 via the access point/router 342, e.g., over 802.11n WiFi. However, other or additional transcoding functionality and/or wireless protocols could be used. The example set-top dongle 332 is an HDMI-capable device that may be operable, e.g., by a user using a remote control 344, to download audiovisual content to the HDTV 328, via the OTA antenna 308, antenna box 316 and access point/router 342, from one or more streaming content sources. Accordingly, in some embodiments, the remote control 344 and the dongle 332 each include an infrared (IR) communication interface. In some other embodiments, the remote control 344 and the dongle 332 each include a radio frequency (RF) communication interface.

Where the HDTV 328 accepts HDMI input and the dongle 332 is included as a node in a viewer's local network, the viewer can stream broadcast content from the antenna 308 and antenna box 316 for viewing on the HDTV 328. Additionally or alternatively, in some embodiments, the system 300 makes it possible for a viewer to stream broadcast content to a smart TV on which a software application provided by the TV manufacturer has been installed that allows the user to play multimedia content from peripheral devices.

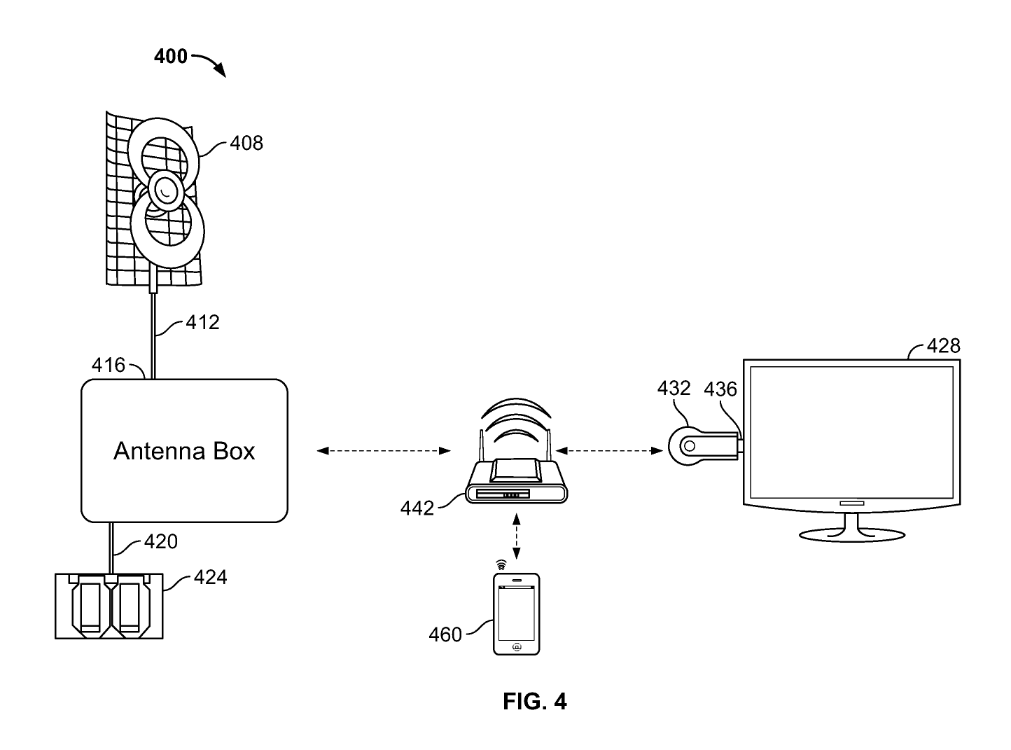

Another example audiovisual (AV) system embodying one or more aspects of the present disclosure is indicated in FIG. 4 by reference number 400. The AV system 400 makes it possible for a viewer to use a third-party dongle or set-top box to stream broadcast content. The AV system 400 is based, e.g., in a residence and includes an outdoor over-the-air (OTA) antenna 408 capable of receiving digital media signals, e.g., HDTV signals that have been multiplexed and broadcast in accordance with ATSC standards. The OTA antenna 408 is, e.g., installed on the roof of the residence and has a wired connection 412 with an antenna box 416. The antenna box 416 is provided, e.g., on or under the roof, in an attic or at some other location, e.g., near the OTA antenna 408. Embodiments also are possible in which the antenna box 416 is integrated into the antenna 408 housing. The antenna box 416 receives power through a wired connection 420 to a power supply 424, e.g., an outdoor AC outlet.

In the present example embodiment, the antenna box 416 is located remotely from a display device, e.g., a high-definition television (HDTV) 428 located, e.g., in a living room of the residence. The antenna box 416 is operable to process OTA signals received from the OTA antenna 408 and to wirelessly transmit the processed signals, via one or more wireless-capable devices remote from the antenna box 416, e.g., for play on the HDTV 428. The antenna box 416 thus includes, e.g., tuner(s), demodulator(s), a processor, and a wireless communication interface, e.g., a WiFi chip set including a receiver, transmitter, a wireless antenna, and transcoding functionality, e.g., H.264, H.265 and/or other compression technologies. In various embodiments, the antenna box 416 includes digital video recording (DVR) functionality, including but not limited to pause and/or recording capabilities.

The example AV system 400 includes a set-top device, e.g., a dongle 432 configured for wired and/or plug-in connection with the HDTV 428, e.g., at a HDMI port 436. The dongle 432 is provided, e.g., by a content-streaming company such as Google®, Amazon®, Apple®, etc., and includes a processor and a wireless communication interface. In various embodiments, a set-top box may be provided additionally or alternatively as a set-top device. The AV system 400 also includes an access point/router 442, e.g., of a local wireless network provided in the residence. The example dongle 432 is configured as a wireless node in the local wireless network.

In the present example embodiment, the antenna box 416 wirelessly transmits H.264-encoded video to the set-top dongle 432 via the access point/router 442, e.g., over 802.11n WiFi. In some other embodiments, however, other or additional transcoding functionality and/or wireless protocols could be used. The example set-top dongle 432 is an HDMI-capable device that may be operable, e.g., by a user using a mobile computing device such as a smartphone 460, to download audiovisual content to the HDTV 428 and/or to the smartphone 460, via the OTA antenna 408, antenna box 416 and access point/router 442, from one or more streaming content sources. Depending on the type of dongle 432, a user may download a software application to the smartphone 460 in order to use the smartphone 460 as a remote control for sending broadcast content to the HDTV 428 and/or smartphone 460. The example dongle 432 may, e.g., stream and/or decode the received content.

The foregoing embodiments make it possible for a viewer to receive, from a wide range of content sources, broadcast content having high signal quality. A cabling run from an antenna to the antenna box can be short, due to the close proximity of the box to the antenna. Because an antenna box often can be located near the antenna and apart from a living room or other viewing area, it can be possible to eliminate a set-top box from the living room or other viewing area.

Various antenna box embodiments having weatherproof enclosures can be installed outdoors or in other exposed locations. Additionally or alternatively, embodiments of the foregoing antenna box are self-starting when power is applied. In various embodiments, a user is able to use and reconfigure his/her AV system without having to access the antenna box after the antenna box has been installed. Example antenna box embodiments can provide intelligent channel scanning during setup and can acquire information such as program guide data, signal strength, etc., from other channels. Further, various antenna box embodiments can adjust their transcoding functionality based on information such as Wi-Fi signal strength, native video resolution, resolution of the display device in use, etc. In various embodiments, an antenna box can provide digital video recording (DVR) functionality, including but not limited to pause and/or recording capabilities.

In exemplary embodiments, the OTA antenna (e.g., 108, 208, 308, 408, etc.) and the antenna box (e.g., 116, 216, 316, 416, etc.) may be configured to allow for use in an outdoor location or an indoor location (e.g., attic, garage, etc.) that is not climate controlled. The antenna box may include a weather proof housing or enclosure in which the electronics (e.g., printed circuit board (PCB), read-only memory including firmware, other electronic components, etc.) are housed and thus protected from the elements (e.g., rain, snow, etc.). The antenna box may include one or more temperature sensors for sensing and monitoring temperature. The antenna box may be configured to automatically shut down if there is a harmful condition in which the temperature is too low or too high (e.g., about 60 degrees Celsius or above, etc.). By way of example, the antenna box may include two temperature sensor circuits spaced apart from each other at two different locations internal to or within the weather proof housing of the antenna box.

The OTA antenna and antenna box may be installed outdoors, such as on a roof, tower, fascia, a mast in a yard, etc. In which case, the antenna box may receive OTA signals from the OTA antenna via a wired connection with the OTA antenna. The antenna box may receive power through a wired connection to a power supply, which may be an outdoor AC outlet. The antenna box may then wireless transmit the OTA signals (e.g., after processing, transcoding, etc.) to one or more wireless-cable devices (e.g., a dongle, a set-top box, an access point (AP), a router, a wireless network bridge, a personal computer, a tablet, a smartphone, etc.) that may be indoors and remote from the antenna box. Accordingly, this may eliminate the need to drill holes in walls, roofs, flooring, etc. that would otherwise be needed for routing a coaxial cable and a power cable from the antenna box. Instead, a power cable may be routed entirely outdoors (e.g., along a roof, wall, etc.) from the antenna box to an outdoor power supply, and the antenna box may wirelessly transmit signals without using a coaxial cable.

In exemplary embodiments, the antenna box (e.g., 116, 216, 316, 416, etc.) may be configured for self-starting upon power up. For example, the antenna box may not include a typical on/off switch. Instead, the antenna box may include firmware operable for self-starting of the antenna box when the antenna box is connected to a power supply, e.g., plugged into an outdoor or indoor AC outlet, etc. The antenna box may also be reconfigurable without having to physically access (e.g., physically touch, etc.) the antenna box. For example, no physical access is needed to setup or access the antenna box as the setup and access can instead all be wirelessly done, such as by using a smartphone, tablet, etc. Also, the antenna box may be configured to automatically recover upon loss of power or loss of Wi-Fi without any user intervention. Accordingly, a user will not have to physically touch the antenna box again after the antenna box is originally installed, e.g., connected to an OTA antenna and plugged into an AC outlet, etc.

In exemplary embodiments, the antenna box (e.g., 116, 216, 316, 416, etc.) may be configured to provide intelligent channel scanning. The antenna box may perform a channel scan upon power up. The antenna box may also continually scan for channels on a regular interval (e.g., 3 AM every night or other user-selected time, etc.) such as when then tuners of the antenna box are not in use. The antenna box may also perform a targeted scan based on the relative location of the antenna box and locations of OTA broadcast stations. The locations of OTA broadcast stations may be obtained from a list of stations that are pre-programmed and/or downloaded from Internet, etc. Using the antenna box location (e.g., a location input by a user, a location automatically determined, etc.) advantageously allows the antenna box to perform a narrower geographic scan for stations (e.g., don't scan for stations more than 500 miles away, etc.), thereby saving time and energy. The antenna box may perform an inferred targeted scan based on an inferred location of the antenna box, which inferred antenna box location is based on the first station found in a channel scan and a list of known broadcast stations and locations.

In exemplary embodiments, the antenna box (e.g., 116, 216, 316, 416, etc.) may be configured to adjust transcoding based on Wi-Fi signal strength, input video resolution, and display resolution. The antenna box may adjust the transcoding to change video parameters (e.g., resolution, bitrate, etc.) based on input source. For example, if the antenna box receives OTA signals or video input at a low video display resolution (e.g., 480 resolution, etc.), then the antenna box may adjust the transcoding so that the video will be displayed at the original 480 resolution instead of a higher resolution (e.g., 1080 resolution, etc.). Advantageously, displaying the video in the original lower resolution allows for a lower bitrate than would the higher resolution. The higher resolution would require a higher bitrate and better WiFi link to support the higher bitrate even though there would not be a benefit to displaying the video at the higher resolution when the video input had a lower resolution.

The antenna box may adjust the transcoding to change video parameters (e.g., resolution, bitrate, etc.) based on the display device (e.g., smartphone, tablet, TV, etc.) and its resolution and/or display screen size. For example, a smartphone may have a smaller resolution and smaller display screen size than a large screen TV, such that it would be very difficult for a user to notice any difference between a video displayed at a 720 resolution versus a 1080 resolution. In this example, the antenna box may adjust the transcoding so that a video will be displayed at a lower resolution (e.g., 720 resolution, etc.) for a smartphone or other small portable devices, and at a higher resolution (e.g., 1080 resolution, etc.) for TVs and other large display devices.

The antenna box may adjust the transcoding to change video parameters (e.g., resolution, bitrate, etc.) based on the available bandwidth of the wireless link. For example, the antenna box may adjust the transcoding so that a video will be displayed at a lower resolution (e.g., 720 resolution, etc.) when the available bandwidth is low or insufficient (e.g., an available bandwidth of 5 megabits per second (Mbps) or less, etc.) to handle higher resolutions, and at a higher resolution (e.g., 1080 resolution, etc.) and when the available bandwidth (e.g., an available bandwidth of 5 Mbps or more, etc.) is high or sufficient to handle higher resolutions.

In various embodiments, the antenna box (e.g., 116, 216, 316, 416, etc.) includes digital video recording (DVR) functionality, including but not limited to pause/rewind buffer. For example, the DVR may be local to the device (e.g., hard drive on the set top box, etc.). Or, for example, the DVR may be on the user's local network (e.g., network attached storage (NAS) or similar, etc.). Yet another example includes the DVR to the cloud.

In a further example, there may be DVR to the cloud with crowd-sourced enhancements such that when users are recording the same broadcast, each user's recording or portion of recording (e.g., 1-5 second video segments, etc.) may be analyzed and then the best recording or portion of recording (e.g., having the highest video data, fewest signal dropouts, etc.) may be selected and used for all viewers to thereby improve the experience for all viewers. The best recording or portion of recording would typically have the highest amount of video information or have the largest file size. When recording portions (e.g., small 1-5 second video segments, etc.) are analyzed to determine a best segment from those recording portions, the selected best segment may then be added a master list. In which case, a crowd-source-enhanced recording may include video portions from many different users rather than just choosing the one single best recording from one user.

There may also be “enhanced live TV” using cloud upload of the video buffer and crowd-sourced enhancements using live streaming. For example, there may be a 5 to 10 second buffer or delay of the live stream to allow for error correction (e.g., signal dropouts, noise, etc.) and thereafter the delayed corrected live stream is sent out. For example, if a user's house is e are correcting typical OTA errors from signal dropout or noise. For example, if a first user's house in a first location is subject to a sudden storm the OTA signal may have more noise or dropout altogether. But a second user in a second location may have a clear day and receive an OTA signal perfectly. So if the OTA signal for the first user is briefly interrupted by the storm and instead of the video going black, the first user may still experience a good signal received via the second user in the second location for that specific video segment.

In exemplary embodiments, the antenna box (e.g., 116, 216, 316, 416, etc.) may be configured to create multiple versions of the same input video using differing video parameters (e.g. a high bitrate stream and a low bitrate stream) for live content or OTA content. For example, the antenna box may serve a display device either a first, low, or lower bitrate video stream (e.g., 1 Mbps bitrate, etc.) or a second, high, or higher bitrate video stream (e.g., 5 Mbps bitrate, etc.) depending on the wireless link quality. Or, for example, the antenna box may first serve a first, low, or lower bitrate video stream to allow for near-immediate video playback because less data would be needed for buffering over a Wi-Fi network, and then the antenna box may serve the second, high, or higher bitrate video stream once playback of the video has started.

In exemplary embodiments, the antenna box (e.g., 116, 216, 316, 416, etc.) may be configured to provide an assisted installation and setup, e.g., using hardware and/or firmware within the housing or enclosure of the antenna box, etc. The antenna box may use signal strength information received from OTA channels to provide guidance to the user for antenna setup and direction, e.g., provide suggestions as to which orientation or direction to aim the OTA antenna, etc. The antenna box may be configured to provide live feedback on the signal strength of a number of user-selected channels to aid in antenna installation and help ensure the user optimizes the antenna installation for the desired channels. For example, the antenna box may be configured to provide suggestions in real time based on selected channels. The antenna box may be configured to provide live feedback on Wi-Fi signal strength to help optimize installation for a reliable Wi-Fi link. For example, during the power on and set up, the antenna box may provide live feedback on how strong or weak the Wi-Fi signal with a quantitative output (e.g., 5 mbs/second, etc.). A pass/fail grade or warning may be provided that may change depending on the video content and/or how many streams the Wi-Fi can support.

In exemplary embodiments, the antenna box (e.g., 116, 216, 316, 416, etc.) may be configured to provide predictive channel changing. For example, the antenna box may include at least two tuners (or first and second tuners) that are capable of being run simultaneously to thereby allow a user to select between the two tuners what will be displayed on the display device. The user may switch back and forth between the OTA content of the first tuner and the OTA content of the second tuner. The first and second tuners may be operating or tuned to different first and second channels. A user may manually change or switch from the first channel of the first tuner to the second channel of the second tuner, thereby change the OTA content that is displayed. Advantageously, having the two tuners running simultaneously allows the broadcast video associated with the second channel to be relatively immediately or instantly displayed after the user makes the channel change despite the antenna box transcoding and serving up the video stream.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. In addition, advantages and improvements that may be achieved with one or more exemplary embodiments of the present disclosure are provided for purpose of illustration only and do not limit the scope of the present disclosure, as exemplary embodiments disclosed herein may provide all or none of the above mentioned advantages and improvements and still fall within the scope of the present disclosure.

Specific dimensions, specific materials, and/or specific shapes disclosed herein are example in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may be suitable for the given parameter (i.e., the disclosure of a first value and a second value for a given parameter can be interpreted as disclosing that any value between the first and second values could also be employed for the given parameter). For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements, intended or stated uses, or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An antenna box comprising one or more processors, one or more tuners,
one or more demodulators, and a wireless communication interface, wherein the antenna box is configured for wired connection with an over-the-air (OTA) antenna, wherein the antenna box is operable to transcode OTA signals received from the OTA antenna and to wirelessly transmit the transcoded signals, via one or more wireless-capable devices remote from the antenna box, for play as audiovisual content on one or more display devices remote from the antenna box, wherein the antenna box is further configured to adjust transcoding of the OTA signals to change one or more video parameters based on one or more of signal strength of wireless communication between the antenna box and the one or more wireless-capable devices, available bandwidth, input source, input video resolution, display resolution, and/or display device.

2. The antenna box of claim 1, wherein the antenna box is configured to adjust the transcoding of the OTA signals so as to decrease resolution of the audiovisual content for the one or more display devices and/or allow a lower bit rate to be used to play the audiovisual content on the one or more display devices.

3. The antenna box of claim 1, wherein the antenna box is configured to adjust the transcoding of the OTA signals received at an original resolution such that the original resolution is maintained for playing the audiovisual content on the one or more display devices, and wherein the original resolution is lower than a resolution of the one or more display devices and therefore allows for use of a lower bitrate.

4. The antenna box of claim 1, wherein the antenna box is configured to adjust the transcoding of the OTA signals based on a resolution and/or a display screen size of the one or more display devices such that the audiovisual content is at a first resolution for a first display device and such that the audiovisual content is at a second resolution higher than the first resolution for a second display device having a resolution and/or a screen size larger than the first display device.

5. The antenna box of claim 1, wherein the antenna box is configured to adjust the transcoding of the OTA signals based on available bandwidth of a wireless link between the antenna box and the one or more wireless-capable devices such that the audiovisual content is at a first resolution for a first available bandwidth and such that the audiovisual content is at a second resolution higher than the first resolution for a second available bandwidth higher than the first available bandwidth.

6. The antenna box of claim 1, wherein the antenna box is configured to perform a targeted channel scan based on a location of the antenna box relative to one or more locations of one or more OTA broadcast stations that are pre-programmed and/or downloaded from the Internet, and/or wherein the antenna box is configured to perform a targeted channel scan based on an inferred location of the antenna box based on a first station found in a channel scan and a list of one or more known broadcast stations and their corresponding one or more locations.

7. The antenna box of claim 1, wherein the antenna box is configured to create multiple versions of a same input video using differing video parameters such that the antenna box is operable for serving the one or more display devices a video stream of OTA content at a first bitrate or at a second bitrate higher than the first bitrate depending on a wireless link quality and/or such that antenna box is operable for first serving the one or more display devices the video stream of OTA content at the first bitrate for a quicker start to video playback and thereafter serve the video stream of OTA content at the second bitrate.

8. The antenna box of claim 1, wherein the antenna box is configured to provide assistance with installation and setup of the OTA antenna including one or more of:
guidance as to which direction to aim the OTA antenna based on signal strength information received from one or more OTA channels; and/or
provide live feedback on signal strength of one or more user-selected channels to help optimize installation of the OTA antenna for the one or more user-selected channels; and/or
provide live feedback on Wi-Fi signal strength as a quantitative output to help optimize installation for a reliable Wi-Fi link depending on video content and/or a maximum number of streams supportable by the Wi-Fi.

9. The antenna box of claim 1, wherein the antenna box includes at least a first tuner and a second tuner that are operable simultaneously and allow a user to change channels from the first tuner to the second tuner, and vice versa, to thereby change from OTA content on the channel of the first tuner to OTA content on the channel of the second tuner, and vice versa, whereby the simultaneous operation of the first and second tuners allows for substantially instantaneous display of OTA content after a channel change.

10. An audiovisual system including the antenna box of claim 1 and further comprising a digital video recorder (DVR) including a pause/rewind buffer and that is local to a device remote from the antenna box, on a user's local network, and/or on the Internet.

11. The audiovisual system of claim 10, wherein the system is configured to analyze each user's recording or portion thereof for a plurality of users recording the same broadcast and then select a best recording or portion thereof for use by all of the plurality of users.

12. The audiovisual system of claim 11, wherein the system is configured to delay a live stream for a predetermined amount of time to allow for error correction and to thereafter serve the corrected live stream for the one or more display devices.

13. An audiovisual system including the antenna box of claim 1, and further comprising the over-the-air (OTA) antenna and a dongle configured for a wired and/or plug-in connection a high-definition television (HDTV) set, the dongle operable to wirelessly receive the transcoded signals from the antenna box and to stream the transcoded signals for display by the HDTV set.

14. A system-performed method of providing over-the-air (OTA) broadcast content, the method comprising transcoding over-the-air (OTA) signals and wirelessly transmitting the transcoded signals from an antenna box, via one or more wireless-capable devices remote from the antenna box, for play as audiovisual content on one or more display devices remote from the antenna box, wherein the transcoding comprises adjusting the transcoding of the OTA signals to change one or more video parameters based on one or more of signal strength of wireless communication between the antenna box and the one or more wireless-capable devices, available bandwidth, input source, input video resolution, display resolution, and/or display device.

15. The method of claim 14, wherein adjusting the transcoding of the OTA signals to change one or more video parameters comprises at least one or more of:
adjusting the transcoding of the OTA signals to decrease resolution of the audiovisual content for the one or more display devices and/or allow a lower bit rate to be used to play the audiovisual content on the one or more display devices; and/or
adjusting the transcoding of the OTA signals received at an original resolution such that the original resolution is maintained for playing the audiovisual content on the one or more display devices, the original resolution being lower than a resolution of the one or more display devices thereby allowing for use of a lower bitrate; and/or
adjusting the transcoding of the OTA signals based on a resolution and/or a display screen size of the one or more display devices such that the audiovisual content is at a first resolution for a first display device and such that the audiovisual content is at a second resolution higher than the first resolution for a second display device having a resolution and/or a screen size larger than the first display device; and/or
adjusting the transcoding of the OTA signals based on available bandwidth of a wireless link between the antenna box and the one or more wireless-capable devices such that the audiovisual content is at a first resolution for a first available bandwidth and such that the audiovisual content is at a second resolution higher than the first resolution for a second available bandwidth higher than the first available bandwidth.

16. The method of claim 14, further comprising:
scanning for channels based on a location of the antenna box relative to one or more locations of one or more OTA broadcast stations that are pre-programmed and/or downloaded from the Internet; and/or
scanning for channels based on an inferred location of the antenna box based on a first station found in a channel scan and a list of one or more known broadcast stations and their corresponding one or more locations.

17. The method of claim 14, further comprising creating multiple versions of a same input video using differing video parameters to thereby allow the antenna box to serve the one or more display devices a video stream of OTA content at a first bitrate or at a second bitrate higher than the first bitrate, and wherein the method further includes:
serving the one or more display devices the video stream of OTA content at the first bitrate or the second bitrate higher than the first bitrate depending on a wireless link quality; and/or
serving the one or more display devices the video stream of OTA content at the first bitrate for a quicker start to video playback and thereafter serving the video stream of the OTA content at the second bitrate.

18. The method of claim 14, further comprising providing assistance with installation and setup of an OTA antenna including one or more of:
providing guidance as to which direction to aim the OTA antenna based on signal strength information received from one or more OTA channels; and/or
providing live feedback on signal strength of one or more user-selected channels to help optimize installation of the OTA antenna for the one or more user-selected channels; and/or
providing live feedback on Wi-Fi signal strength as a quantitative output to help optimize installation for a reliable Wi-Fi link depending on video content and/or a maximum number of streams supportable by the Wi-Fi.

19. The method of claim 14, further comprising simultaneously operating first and second tuners of the antenna box thereby allowing a user to change channels from the first tuner to the second tuner, and vice versa, to thereby change from the OTA content on the channel of the first tuner to the OTA content on the channel of the second tuner, and vice versa, whereby the simultaneous operation of the first and second tuners allows for substantially instantaneous display of the OTA content after the channel change.

20. The method of claim 14, further comprising:
analyzing each user's recording or portion thereof for a plurality of users recording the same broadcast and selecting a best recording or portion thereof for use by all of the plurality of users; and/or
delaying a live stream for a predetermined amount of time to allow for error correction and thereafter serving the corrected live stream for the one or more display devices.
